(19) United States
(12) Patent Application Publication
(10) Pub. No.: US 2006/0200582 A1
(43) Pub. Date: Sep. 7, 2006

(54) Unique identifier addressing and messaging enabling transfer of digital communication, content, and commerce

(76) Inventor: Andrew Michael Phipps, Phoenix, AZ (US)

Correspondence Address: Andrew Michael Phipps, 1008 E Northern Avenue, Phoenix, AZ, 85020, US

(21) Appl. No.: 11/359,118

(22) Filed: Feb. 21, 2006

Related U.S. Application Data
(60) Provisional application No. 60/655,494, filed on Feb. 22, 2005.
(60) Provisional application No. 60/656,015, filed on Feb. 23, 2005.

(51) Int. Cl. G06F 15/16

(52) U.S. Cl. 709/245

(57) ABSTRACT

A method and system to convert a plurality of unique identifiers (license plates) from defined certain defined classes of unique identifiers (i.e. license plates) into electronic addresses enabling digital communication, content, and commerce to be transferred to the associated address, whereby a verified rightful holder of the unique identifier can claim by contract; rights which can grant access to the digital data that has been transferred to the assigned electronic address. It is an object, in some aspects, to allow a sender without knowing the identity of the holder of the unique identifier, to communicate a message, send money, pictures, and files to the converted corresponding electronic address in the hopes that the holder will claim the email address through a verification process. In order to facilitate the invention a central domain repository is used to determine and publish a uniform convention for the unique identifier, to establish a standard that is universal. The preferred embodiment of the invention is in the inventions ability to be utilized as a universal uniform international standard email address assignment to all legally valid alphanumeric license plate numbers.

### CROSS-REFERENCE TO RELATED APPLICATIONS AND CLAIM OF PRIORITY

This application claims the benefit of priority under 35 U.S.C. Section. 199(e) to U.S. Provisional Application No. 60/656,494, filed Feb. 22, 2005, entitled “Unique Identifier Addressing Enabling Transfer of Digital Communication, Content, and Commerce” and to U.S. Provisional Application No. 60/656,015, filed Feb. 23, 2005, entitled “Unique Identifier Messaging”. The U.S. provisional applications described above are hereby incorporated by reference herein, in their entirety, as if set forth in full.

### FIELD OF INVENTION

The present invention generally relates to a method and system of converting a unique identifier (i.e. legally valid alphanumeric license plate number) into an associated or corresponding email address, according to a published convention contained at a central domain repository (i.e. website) enabling online transfer of digital data, including but not limited to transfer of digital communication, content, and commerce; to the assigned electronic address for the unique identifier (i.e. license plate number). The present invention includes the field of unique identifier messaging, such as license-plate based messaging to virtually anyone, anything, anytime, anywhere.

### BACKGROUND OF THE INVENTION

Prior art in this field has focused on the need for a person to access a central database (i.e. Department of Motor Vehicles), in order to communicate with another based on a unique identifier (i.e. license plate) of a defined class of identifiers (i.e. license plates, social security numbers, telephone numbers), as well as to determine the identity of the rightful holder of a unique identifier (i.e. license plate), obtaining from the database the holders personal information, including address, in order for one person or entity to communicate, deliver content, or conduct commerce with the holder of the unique identifier (i.e. license plate). Restrictions are placed on access to this central database to protect the privacy of the holder or the unique identifier (i.e. protect identity of holder of a license plate). An obvious concept to enable communication between parties based on identifiers, such as license plates, was to host a database on the web and provide access to the database to obtain contact information for another based on their identifier, or even more obvious to allow the person to send a message to a website acting as a clearinghouse, and then this clearinghouse proposed to forward the message on to an email address for the person associated with the license plate. The problem with the aforementioned approach was that its success would depend on the ability to attract the mass scale of license placeholders that exist to sign up and provide their contact information; the ability for this approach to succeed commercially was nil.

### SUMMARY OF THE INVENTION

In accordance with this invention, a method and system of converting a unique identifier (i.e. legally valid alphanumeric license plate) into a corresponding electronic address (i.e. email address) by means of referencing a central domain repositories (i.e. server) website for the published uniform convention of a definitive class of unique identifiers (i.e. legally valid alphanumeric license plates), enabling anyone, anywhere, anytime to transfer digital data, including but not limited to communication, content, and commerce to a unique identifier(s) corresponding electronic address, such as but not limited to, an email address.

In accordance with this invention, the unique identifier(s) corresponding electronic address is hosted at a central domain repository (i.e. mail server), incoming digital communication, content and commerce, would be forwarded to a mail client if one exists for the email, or a catch-all address for the domain name of the central domain repository used in the convention of the communication would receive and store the digital data for access by site administration. Senders of digital data can include variables in the sending of any digital communication, such as including but not limited to, a subject line in an email that deems the communication “public” or “private”. A listing of variables and there corresponding value can be published at a website provided by the central domain repository. For example, a digital communication sent to a license plate number's corresponding address could include a subject line that contains the word “public”, which would indicate to the central domain repository that the sender would like the site administrator to post the contents to its website in order for the communication or content to be viewable by the public and hopefully the rightful holder of the license plate number. Alternatively, in accordance with the invention, a subject line that contains the word “private”, which would indicate to the central domain repository that the sender would like the site administrator to store the digital communication, content and commerce, for later retrieval by someone who claims and is verified by the central domain repository as the rightful holder of the license plate.

It is an object of some aspects of the invention to contract with the senders and receivers of digital data to the unique identifiers corresponding address, including but not limited to transmission of communication, content, and commerce via the central domain repository.

In preferred embodiments of the present invention, a domain name at a specific URL hosts a website where a uniform convention for conversion of a legally valid alphanumeric license plate number to an email address are published. A conversion for a license plate number, as a defined class of unique identifiers, could have the following convention:

License Plate Conversion to Email Address Convention

Using a string sequence as in a standard email format
Element 1: string sequence is the alphanumeric license plate number
Element 2: string sequence is a period or dot (used to define parameters of plate number)
Element 3: string sequence is a US postal code or country postal code abbreviation
Element 4: string sequence is an @ symbol
Element 5: string sequence is the assigned domain name for the central domain repository
Element 6: string sequence is a period or dot (used to separate domain name and top-level domain name.
Element 7: string sequence is the assigned top-level domain for the central domain repository.

Using the preceding convention it would enable a person utilizing this method anywhere, anytime; who so wanted or needed to contact virtually anyone, to view any legally valid license plate and instantly know that a digital communication could be sent to an email address already existing residing on a mail server at a central domain repository which corresponds and associates with that license plate, and furthermore, in accordance with this invention, where a rightful holder (i.e. driver of the car containing the license plate) could receive that communication by contracting with the central domain repository for access to the communication. A central domain repository can have a mail server residing at a domain name, such as Platestate.com, in accordance with this invention. A person views a license plate on a car on a freeway; the license plate contains the alphanumeric characters “USA111” and indicates the issuing state as California; the person using the conversion herein contained would know to address the license plate at USA111.CA@PLATESTATE.COM. A driver of a car who is the rightful holder of that license plate can then visit the central domain repository, in this example PLATESTATE.COM and then do a search or contact the site administrator to determine if his or her license plate has received any digital communication, content, and/or commerce. If there is a communication that the mail server hosted by platestate.com has received, then this communication can be posted to the website for public viewing, or the rightful holder can contract and be verified with the central domain repository for access privately to the digital communication, content, or commerce via claiming through registration procedures the assigned email address and being provided a mail client with secure password access to the email, or having emails sent to the license plates corresponding email address forwarded to another email address provided by the verified and contracted rightful holder of the license plate.

In accordance with the invention, no prior registration by a rightful holder of a unique identifier is necessary at the central domain repository, since the digital communication is addressed to the object itself, the unique identifier, rather than the person who is the rightful holder of the object.

In accordance with the invention, the central domain repository acts as a gateway for the transfer of all digital data. Data transmitted via the gateway is stored on a server assigned for such purpose, and handled according to site administrator rules, and transmitted at a later time according to this invention and established rules by the site administrator.

In accordance with this invention, a verification method for determining the identity of the actual rightful holder of the license plate or other unique identifier, consisting of publishing an accessible verification policy and procedure instructions at the central domain repository, requesting supporting documentation, including but not limited to an affidavit, a signed release of personal information from a state DMV, a copy of a car registration, a drivers license, and/or a credit card number; requesting a fax, email or any other acceptable delivery method, of said supporting documents to the central domain repository. Information provided is then validated by making a request to a state agency to validate the authenticity of the claimed rightful holder to the unique identifier.

In accordance with this invention, digital content can be sent to a unique identifiers converted corresponding email address. A driver of one car can take a picture of him self, and send the picture to the converted email address of a license plate in hopes that the driver of the car with the license plate makes access with the website of the central domain repository.

In accordance with this invention, monetary transactions can be sent to a unique identifiers converted corresponding email address. A person, without knowing the actual identity of the rightful holder of a unique identifier, such as a license plate, can send monies via an online payment solution, such as PayPal®, to the converted email address of a unique identifier of which a rightful holder of the unique identifier is later verified can receive these monies, and these monies can be a consideration for a good and/or service, a gift, or just a donation.

In accordance with this invention, a claim for a method and system for converting a unique identifier, from a defined class of unique identifiers; distinctly including but not limited to license plates, social security numbers, credit card numbers, or anything else within the scope, into a corresponding electronic address (i.e. email address) or anything else within the scope, comprising: hosting an internet accessible central domain repository, including but not limited to an internet website destination accessible via a uniform resource locater, publishing a convention of conversion for a defined class of unique identifiers, including but not limited to a legally valid alphanumeric license plate number, a legally valid social security number, a valid credit card number, or anything else within the scope; into an online accessible address, including but not limited to an email address, or anything else within the scope.

### BRIEF DESCRIPTION OF DRAWINGS

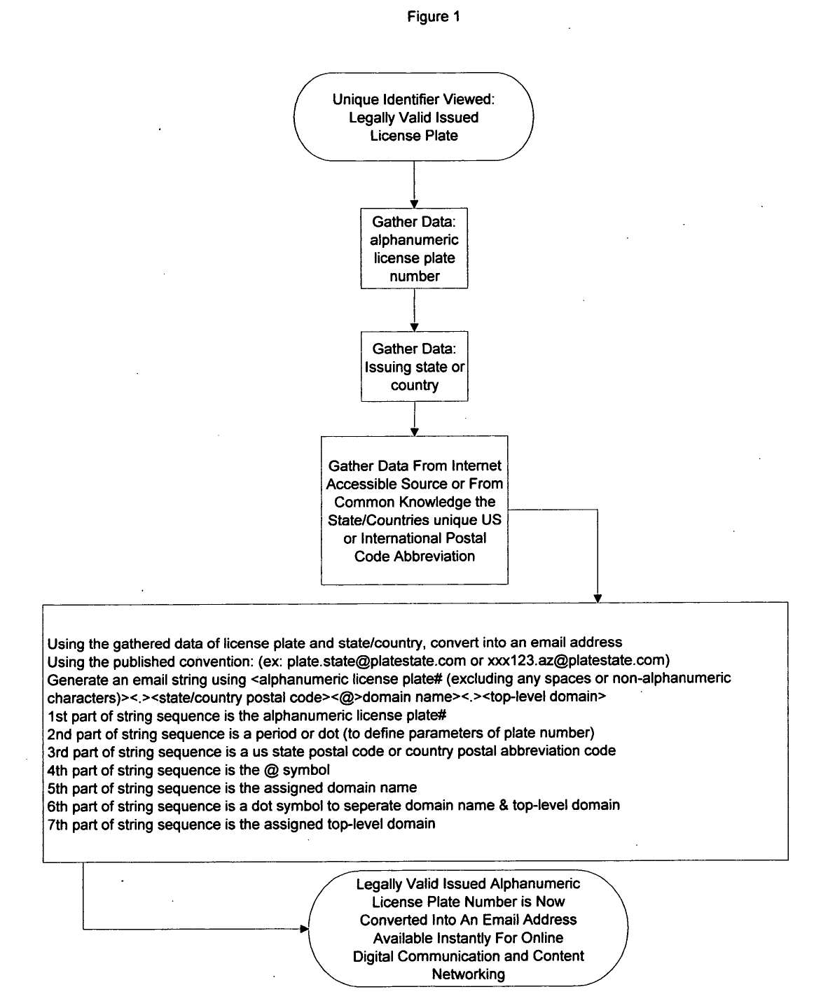

Referring to FIG. 1 is a flowchart diagram of the process in converting a unique identifier, in this example a license plate, to an email address.

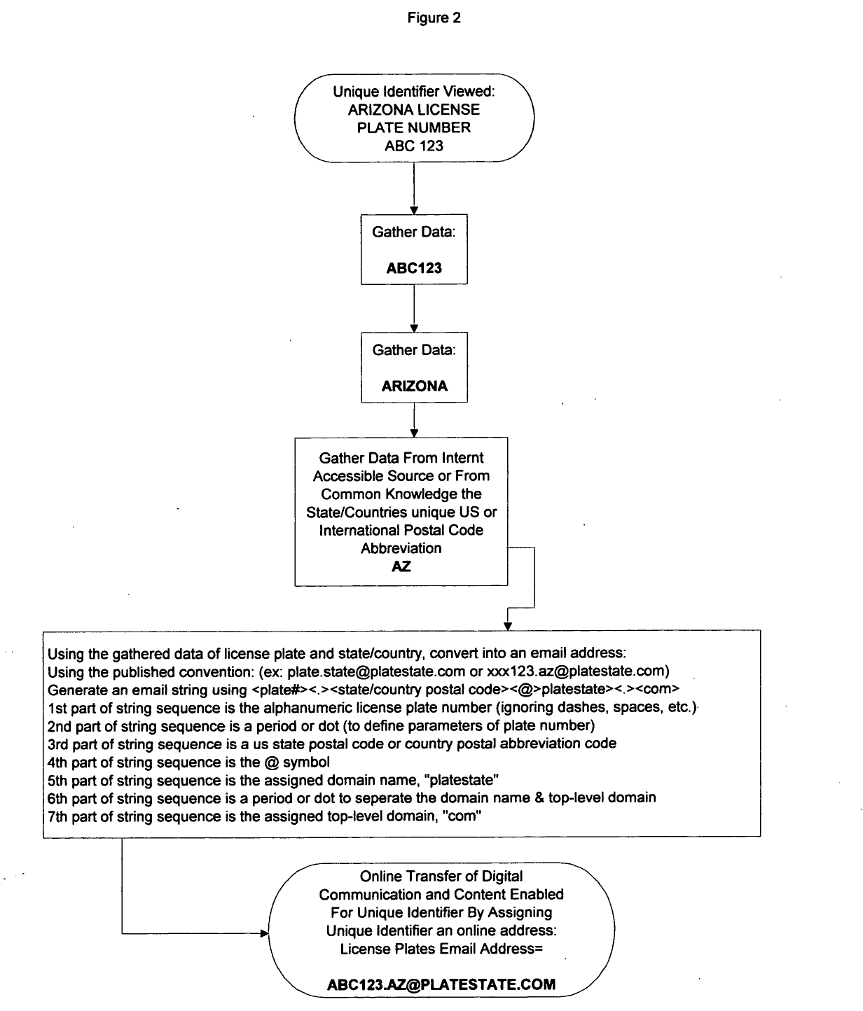

Referring to FIG. 2 is a flowchart diagram of a theoretical license plate to email address conversion.

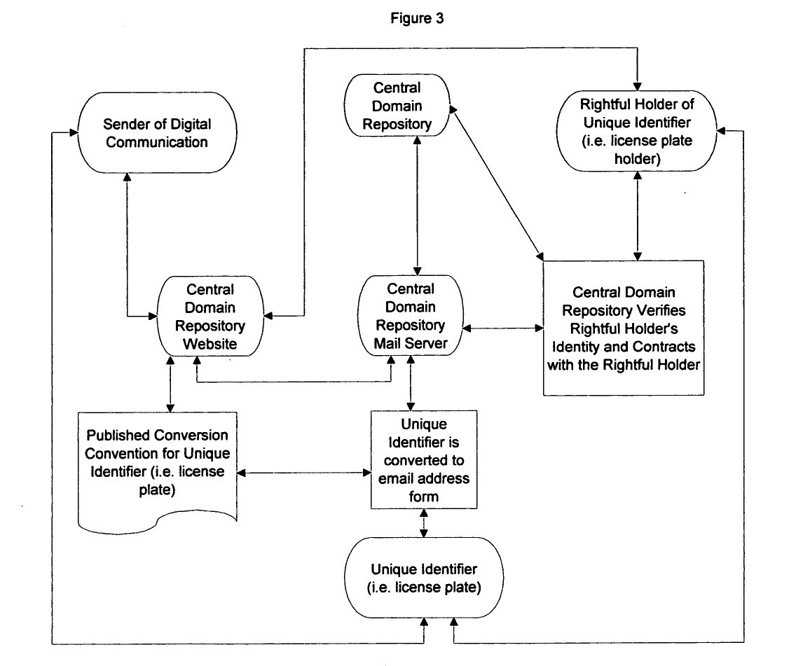

Referring to FIG. 3, in accordance with the invention, is a diagram of the relationship between the central domain repository (site administrator), central domain repository mail server, central domain repository website, the sender of a digital communication using the invention, the unique identifier, the central domain repository contract and verification process of the rightful holder of the unique identifier, the rightful holder of the unique identifier, the published conversion convention. Sender of digital communication views website, learns about the ability to send communications to license plate holders, according to the invention process and method. The sender views a license plate, converts into an email address according to the invention, and sends communication. The central domain repository receives the digital communication on a mail server assigned according to the invention and the central domain repository site administrator audits the message. A rightful holder of the license plate visits the central domain registry and views to see if any communications were sent to his or her license plate, in turn a rightful holder can contract and be verified by the central domain repository as the verified rightful holder of the license plate. The central domain repository grants access to the mail server to the rightful holder to have access to an email account corresponding for email addressed to the license plate.

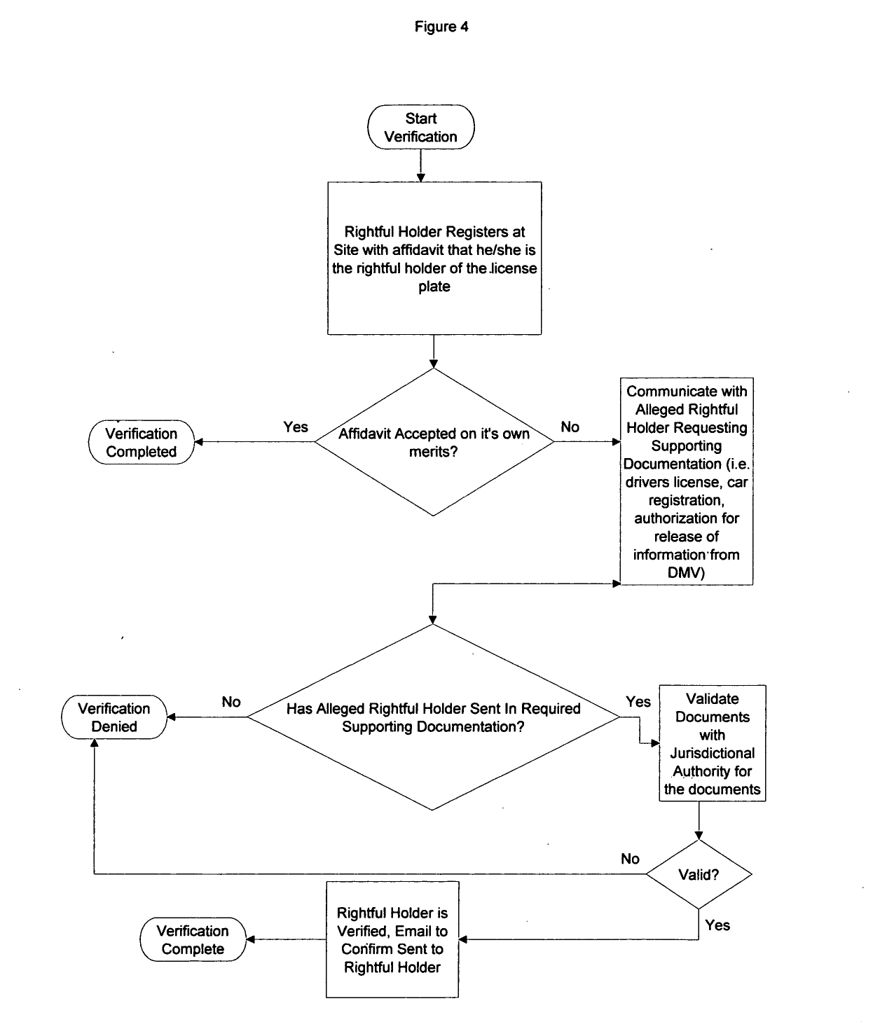

Referring to FIG. 4 is a flow chart diagram of the verification of the rightful holder of a unique identifier, according to the invention.

1. A method for converting a unique identifier from a defined class of identifiers; including but not limited to a legally valid alphanumeric license plate number, a social security number, a credit card number, or anything else within the scope, into a corresponding electronic address, including but not limited to an email address, instant messaging address, or anything else within the scope, comprising: hosting an internet accessible central domain repository, including but not limited to an internet website destination, accessible via a uniform resource locater; publishing a defined uniform standard convention at the central domain repository utilized for converting a unique identifier from a defined class of identifiers, such as a legal alphanumeric license plate number to an electronic address. In accordance this claim, furthermore; includes anything else within the scope.

2. In accordance with claim 1 a method for a central domain repository, including but not limited to a website or anything else within the scope, to serve as a gateway for transfers of digital communications, content, and commerce, comprising: an internet accessible central domain repository, sending and receiving digital data, storing the digital data, granting access to digital data to mail clients, forwarding digital data to the respective holder of the unique identifier, and/or posting the communication for public viewing, preferably on a website or anything else within the scope. In accordance this claim, furthermore; includes anything else within the scope.

3. In accordance with claim 1, and claim 2, a method and system for filtering digital communications comprising: utilizing pre-defined variables corresponding with certain defined values that are published at a central domain repository; including but not limited to using subject line of an email communication to indicate “public” or “private”, with “public” having a value of x and “private” having a value of y; or anything else within the scope. In accordance this claim, furthermore, includes anything else within the scope.

4. In accordance with claim 1 a method and system for establishing a connection with a unique identifier across a globally connected network, comprising: associating an electronic address, assigning the conversions corresponding electronic address with the holder of the unique identifier upon contract with the holder, whereby an originating electronic address, including but not limited to an email address or anything else within the scope, can connect electronically with the destination address. In accordance this claim, furthermore; includes anything else within the scope.

5. In accordance with claim 1 a method and system for sharing of digital content with another based on addressing their unique identifier, comprising: sharing via email, instant messaging, or anything else within the scope. In accordance this claim, furthermore; includes anything else within the scope.

6. In accordance with claim 1 a method and system for associating a unique identifier, and its corresponding electronic address, with a location reporting system, comprising: a holder of a unique identifier registers at the central domain repository as the rightful holder of the unique identifier, the holder is successfully verified and contracts with the central domain repository (i.e. website), holder using a location tracking device, including but not limited to GPS, RFID or anything else within the scope, that transmits a geographic reporting of the location of the unique identifier, or at the very least another object tethered to the object, such as, but not limited to a car or anything else within the scope, a query is made to a server storing the location information that is transmitted from the tracking device and uploaded to an internet based server, the location information is associated with the unique identifier, via a lookup table and stored memory at the central domain repository, and a mapping of the location is pinpointed, displayed on an internet-based imaging of a geographic map of the location, including but not limited to objects or a plurality of other unique identifiers within close proximity. In accordance this claim, furthermore; includes anything else within the scope.

7. In accordance with claim 1 a method and system for monetary transactions in relation to a unique identifier, comprising: monies sent, such as a sender utilizing an online payment solution (i.e. PayPal®) from an originating point to a destination point being the electronic address corresponding with the unique identifier. In accordance this claim, furthermore; includes anything else within the scope.

8. In accordance with claim 7 a method and system for monetary compensation, comprising: a transaction of a good, service, or referral of value resulting from a unique identifier, such as being viewed by a contracting member of the central repository; the remuneration of monies to a unique identifiers address, including but not limited to a unique identifiers rightful holder. In accordance this claim, furthermore; includes anything else within the scope.

9. In accordance, with claim 1, a system or method, comprising: a mail server utilizing a central domain name repository domain name (i.e. platestate.com) to receive all digital communications, content, and/or commerce transferred via the mail server, and using a primary email address as a catch-all email address for all communications intended for a plurality of possible email addresses at that mail server, incoming and outgoing and anything else within the scope. In accordance this claim, furthermore; includes anything else within the scope.

10. In accordance with claim 1, a method and system for registering a rightful holder of a unique identifier; including but not limited to a license plate, a social security number, a credit card number, or anything else within the scope, to an internet-based address, including but not limited to an email address or anything else within the scope, comprising: a central domain repository, including but not limited to a website or anything else within the scope, a data compiling source, including but not limited to a scripted form or anything else within the scope, a submission of data to a central domain repository, including but not limited to a web server or anything else within the scope, an automated reply confirming registration, including but not limited to email reply or anything else within the scope. In accordance this claim, furthermore; includes anything else within the scope.

11. In accordance with claim 10, a method and system for verification of a holder of a unique identifier, comprising: a central domain repository, a published procedure for verification, a published fax number where supporting documentation can be submitted, an authorization letter for release of information from a third party (i.e. Department of Motor Vehicles) posted to a website for a holder, a PDF formatted document that can be downloaded by the holder and faxed to the fax number, a verification staff receives documentation and validates via third party authority for authenticity; or anything else within the scope. In accordance this claim, furthermore; includes anything else within the scope.

12. In accordance with claim 11 a method and system for a rightful holder of a unique identifier (i.e. license plate) to register at the central repository to be matched with the unique identifier address, comprising: Accessing a website, completing an online form, including but not limited to providing information pertaining to the unique identifier, such as providing a legally valid license plate's alphanumeric number and issuing state. Entering the referring unique identifier, such as the Plate and State you viewed that caused the user to go to the website. Providing a name on a confidential basis. Providing a zip code. Providing an address. Providing a phone number on an optional basis. Providing an existing valid email address. An option to include an email address of a friend. An option to type a message to the email of a friend that you would like to inform of the website. In accordance this claim, furthermore; includes anything else within the scope.
